(19) United States
(12) Patent Application Publication
(10) Pub. No.: US 2005/0283396 A1
(43) Pub. Date: Dec. 22, 2005

(54) Drafting system and method for the music industry

(76) Inventor: Eric Ola Rhodes, Houston, TX (US)

Correspondence Address: Delphine M. James;Attorney-at-Law, Ste. 170, 2656 South Loop West, Houston, TX, 77054, US

(21) Appl. No.: 10/870,174

(22) Filed: Jun. 17, 2004

(51) Int. Cl. G06F 17/60

(52) U.S. Cl. 705/11

(57) ABSTRACT

The present invention provides a system and method for providing a plurality of contestants each an opportunity to obtain a recording contract with participating record label. Each participating record label company is registered into a facilitating management server. For each registered record label company, a predetermined number of contestant entry reward coupons are issued. Each coupon is tied to the purchase of a music media by a consumer. For a predetermined period of time, a plurality of interested consumers is allowed to redeem their coupons and register for the contest through the facilitating management server. After the consumer registration period is over, the facilitating management server selects a predetermined number of contestants to compete in an auditioning process. The facilitating management server monitors the auditioning process of each selected contestant. After the final round of auditions, final round draft contestants are selected contestants to compete for recording contracts. With the present invention, each member of the group can be selected for a recording contract by a participating record label based upon their performance during the final auditioning process.

### BACKGROUND

The present invention relates to a method and system for enhancing sales in the music industry. The record industry is currently fighting the following battles:
Decline in sales of recorded music
Increase piracy sales
Illegal online file swapping/downloading

As a result of the above mentioned reasons, the music sales between 2000 and 2002 are down 30% and pirated compact disc sales rose approximately 14% in 2002 while reported music sales declined by 15.8% in the first half of 2003 compared to the same period in 2002. By associating a reward system with the purchase of recorded music media such as compact disc consumers are driven back to the stores to purchase the music media. The reward system is expected to discourage many consumers from buying pirated music and illegally downloading music online. There are many talent contests systems in the prior art for example American IDOL and Star Search. Additionally, US PAT NO U.S. 2003/0171982 discloses a process for finding the best rap musicians. However, the present system and method of the invention is augmented with a talent drafting process which simultaneously enhances music sales and brings talent to the forefront.

### SUMMARY

The present invention provides a system and method for providing a plurality of contestants each an opportunity to obtain a recording contract with participating record label company. Each participating record label company is registered with the facilitating manager. For each registered record label company, a predetermined number of contestant entry reward coupons are issued. Each coupon is tied to the purchase of a music media by a consumer. For a predetermined period of time, a plurality of interested consumers is allowed to redeem their coupons and to register for the contest through the facilitating manager. After the consumer registration period is over, the facilitating manager selects a predetermined number of contestants to compete in an auditioning process. The facilitating management server monitors the auditioning process of each selected contestant. After the final round of auditions, final round draft contestants are ranked based upon their performances. However, eligible participating record label companies are not bound by the draft rankings when selecting draft picks for a contract. With the present invention, each member of the group can be selected for a recording contract by a participating record label based upon their performance during the final auditioning process.

### BRIEF DESCRIPTION OF DRAWINGS

FIG. 1 illustrates a block diagram of the system process.

FIG. 1A illustrates a block diagram of the system components.

FIG. 2 illustrates the system architecture to support the system process and components.

FIG. 3 illustrates a block diagram of the registration process for record labels and contestants.

FIG. 4 illustrates a block diagram of the auditioning process of the contestants.

FIG. 5 illustrates an example of the consumer registration process.

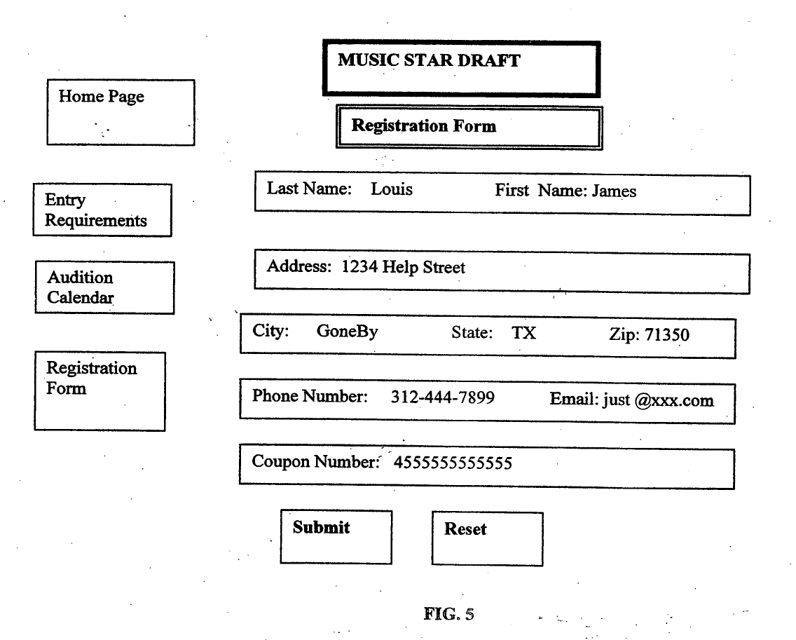

### DETAILED SPECIFICATION

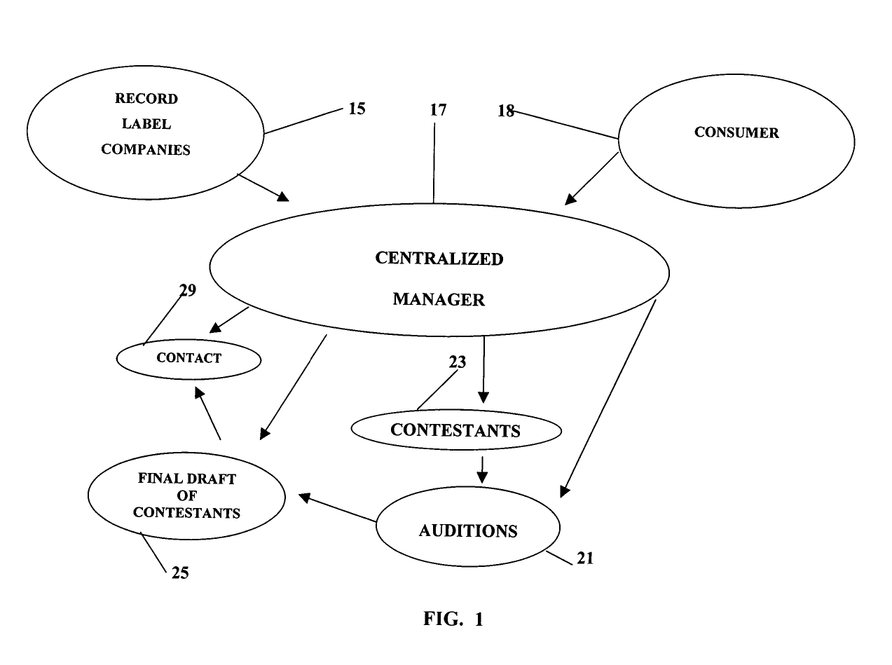

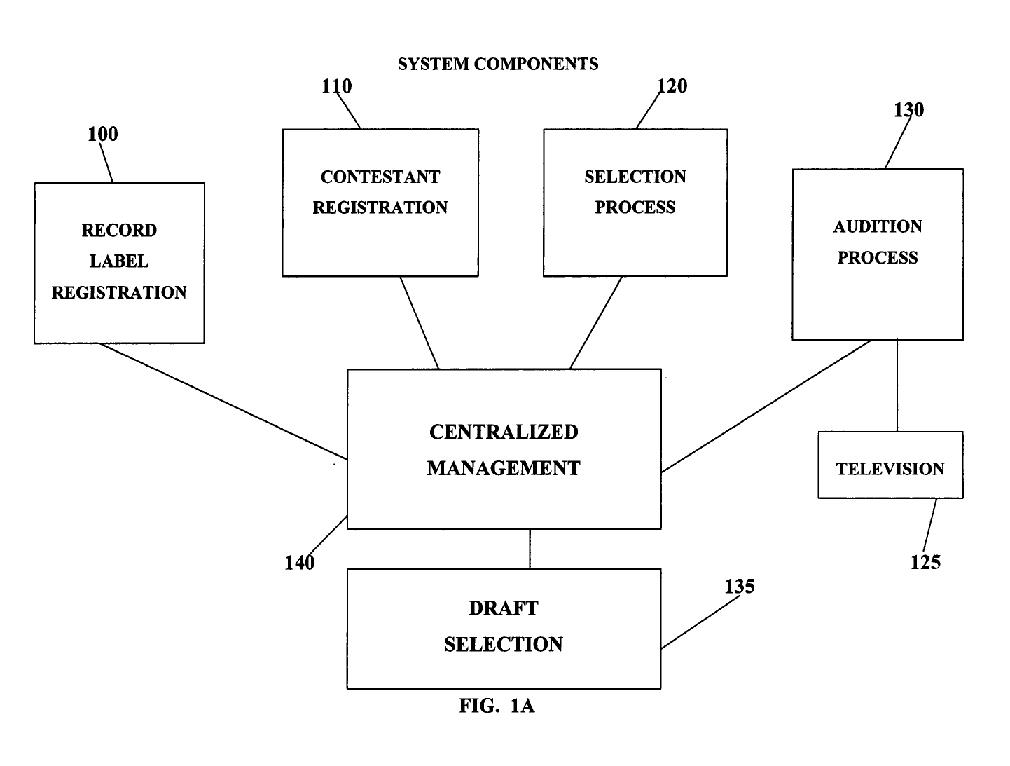

Referring to FIG. 1, there is shown a block diagram of the overall process implementing the Music Industry Draft system components illustrated in FIG. 1A. In FIG. 1, recording label companies (15) register with the facilitating manager (17) and the consumer (18) register with the facilitating manager (19). The facilitating manager (17) selects contestants (23) to participate in auditions (21). After several round of auditions (21), a final draft of contestants (25) are selected to perform in a final round of auditions. Several of the final draft contestants (25) can be awarded contracts (29) provided by record label companies (15).

Referring to FIG. 1A, there is shown a one embodiment of the system components to implement the overall process depicted in FIG. 1. The main components of the system as illustrated in FIG. 1A are:
a facilitating management (140) component for controlling and managing the access between the database system and the other system components. The facilitating manager can be implemented in a centralized server or through a plurality of integrated servers.
a record label company registration component (100) for registering sponsoring record label companies.
a contestant registration component (110) for accepting registration of various consumers.
a selection process component (120) for selecting contestants from the registered consumers.
an auditioning component (130) for tracking and monitoring the auditioning process
a draft selection (135) component for tracking and monitoring the final round of auditions.
television component (125) for auditioning and telecasting of the draft process

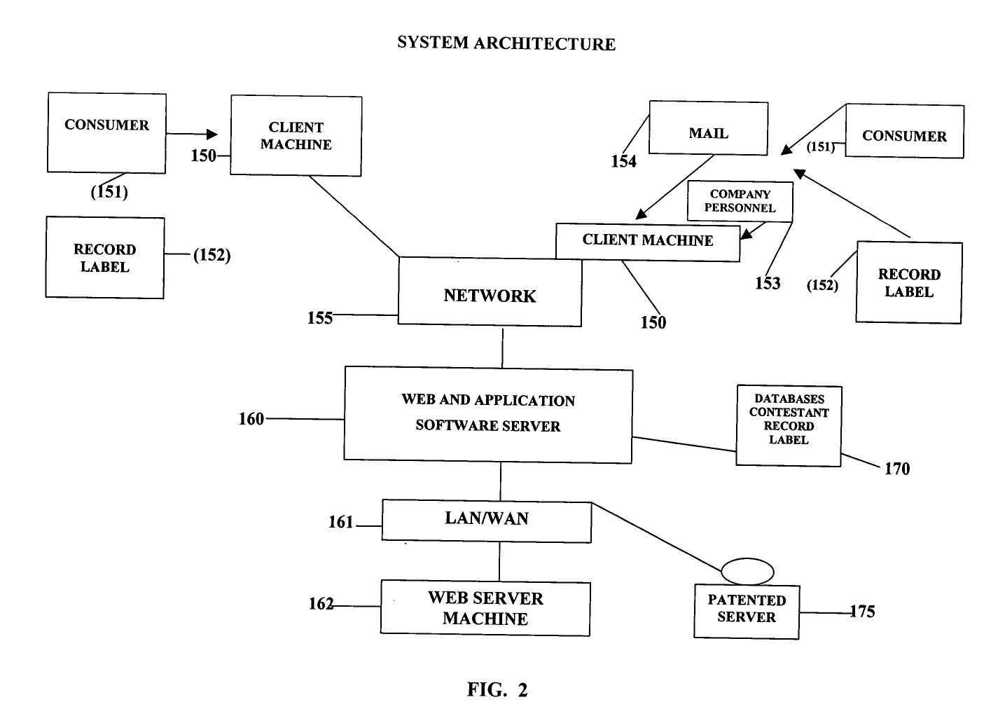

Referring to FIG. 2, there is shown a block diagram of the system hardware architecture to support the system. The system can be implemented in a client server environment utilizing on a computer network i.e. LAN, WAN or the Internet. A consumer (151) or the record label company (152) utilizes a client machine (150) such as a personal computing device (150) to register over the network (15) with the system server (160). Alternatively, the consumer (151) or the record label company (152) mails in their registration to the company personnel (153). The company personnel (153) register with the system server (160) over the network (155) utilizing a client machine (150).

Personal computing device (150) can be a desktop, laptop, notebook, mobile phone or a suitable computing device to access the system executing on the web servers (10). Each personal computing device (150) can utilize conventional internet service provider software such as AOL, SBC or another provider to establish a connection to the system WEB server (160) utilizing conventional data communication protocols. The conventional communication protocol is generally TCP/IP. Additionally, proprietary client software can be developed to connect to Web Server (160) utilizing the conventional communication protocols.

The web server machine (160) provides the services over the network. In this case, the server machine (160) provides a web application for registering record label companies and contestants into the system. Additionally, there is a back office administration function of monitoring and tracking the contestants throughout the auditioning and draft selection process.

At least one web servers (160) house the website pages and the software required to support the system application to be described below. If multiple web servers are required, then web servers (160 and 162) can be networked together in a LAN and/or WAN (161). At least one database is required to support the system. Databases (170) are required to store information on the record label companies, contestants, and the auditioning process. The databases (170) can reside on the system server machine (160) or can be stored or a separate database server machine (175) which can be networked through a LAN and/or WAN (161).

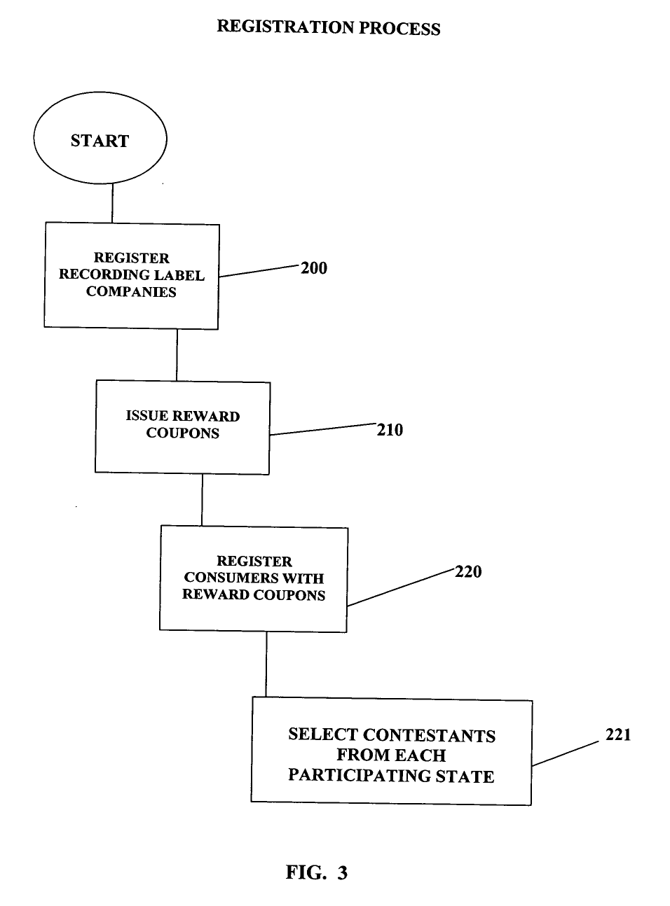

Referring to FIG. 3, there is shown a block diagram of the registration process. At step 200, each participating record label company is registered. Each registered record label company agrees to sponsor the contest and to award contracts to the final draft round of contestants. A data record is created and stored in the database system for each participating record label company.

At step 210, for each registered company a predetermined number of reward coupons are issued. The record label company determines which CD's will have the coupons. The system provides a set number of coupons for each participating CD from the record label. Each issued coupon is tracked by the bar number of its associated CD.

At step 220, a consumer accesses the system to register for the contest. The consumer must register with a legally obtained coupon. To redeem the coupon and register for the contest, the consumer provides the bar number of the CD. The consumer also has the option of mailing in their registration form. When the consumer chooses to do registration by mail, the company personnel accesses the system and performs the step of registration for the consumer.

The consumer registration process occurs for a set period of time. At step 221, after the consumer registration process is over, the system chooses a predetermined number of contestants from each participating state. All fifty states can participate in the registration process. The algorithm utilized to choose the contestants can be variable. For example, the system can choose the contestants based upon some random number generator algorithm in addition a predetermined number of contestants can be selected prior to the invocation of the random number generator. The system then notifies each selected contestant, the time and place of their audition. In some embodiments, at the sole discretion of the facilitating manager an individual from a recognized talent contest can be included into the auditioning process prior to the final industry draft round.

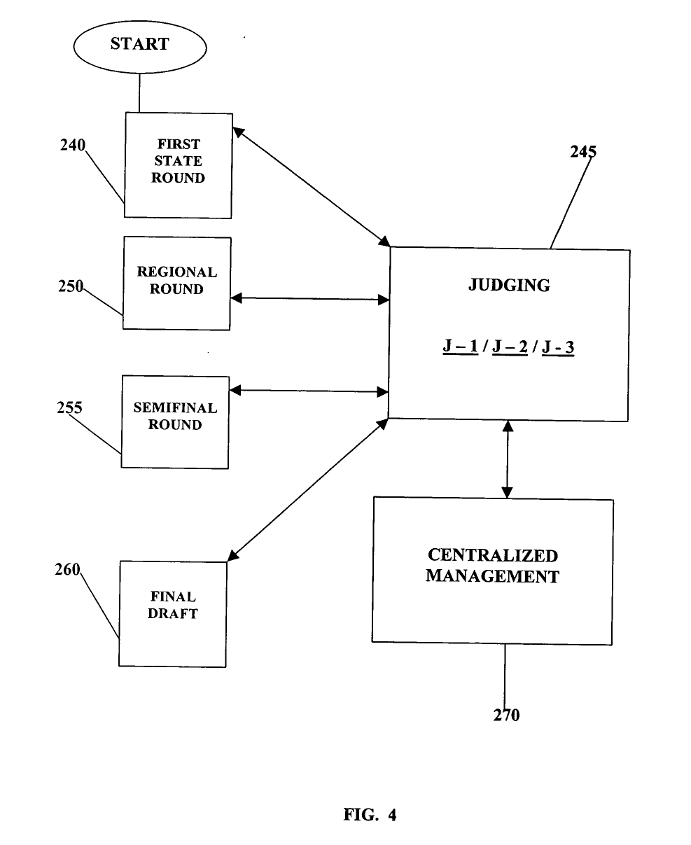

Referring to FIG. 4, there is shown a block diagram of the auditioning process. After the contestants are selected from each participating state, the contestants enter the auditioning process. The system tracks the performance of each contestant through each round of their auditions. A host is selected for each round of auditions. The host can be the same or selected from a panel of hosts.

The auditioning process can be at least two rounds but preferable the auditioning process is four rounds as shown in FIG. 4. Each of the four rounds can be broken down into a number of stages. Each stage consists of the performance of subset of the total group of contestants. Additionally, each stage can be judged independently of each other and later the performance of each stage can be merged together to judge the overall performance for a particular round.

At step 240 each selected contestants enters the first round which is the state auditions. For a set period of time in each participating state, each selected contestant performs live auditions. The live auditions can be broadcasted on television or not. Additionally, a predetermined number of judges are provided to evaluate the performance of each selected contestant in their audition. Upon completion of the audition, each judge provides a rating score for each performing contestant. Each judge (245) or company personnel can utilize a client machine to access the facilitating management server (270) to record the rating score for each contestant. The facilitating management server (270) collects the score of each contestant in each state and determines which contestant moves on to the next round based upon the majority decision of the judges. Additionally, viewers can utilize a client machine to access the facilitating management server to record a rating score for each performing contestant. The facilitating management server (270) compares the rating score of the contestants chosen by the judges and the contestants chosen by the viewers. If the majority decision by the judges is different from the popular vote of the viewers, the judges initial selection can be subjected to a review by a new panel of judges who will select the contestants that move on to the next round of auditions. Additionally, the number of judges can vary. In alternative embodiments, the viewer can call or text messaging into the facilitating management server (270) to provide a rating score.

Upon completion of the final selections by the facilitating management server, the selected contestants are notified of the time and place of the next round of auditions. As depicted, at step 250, the second round of auditions can be regional. Then, at step 255, the third round of auditions can be based upon a regional geographic area such as the east coast versus the west coast. Additionally, if a particular geographical area outperforms another regional area, a performance advantage can be awarded to the latter regional area. The performance advantage can take the form of more contestants being chosen from that geographical area. The awarded performance advantage to a region can vary.

Upon the completion of the second round a group of contestants are chosen to proceed to the fourth round. Live auditions are performed in both the third and fourth round of auditions. The judging process in step (245) proceeds as described above in step 240.

Upon completion of the third round of auditions, at step 260, a final round draft is selected by the facilitating management server (270). Live auditions are performed in this round. The judging process in step (245) proceeds as described above in step 240. However, at the end of the final round of auditions the draft selections the facilitating management server (270) prioritizes the draft selections based upon their performance during the final round. At the end of the final round, a recording contract can be awarded to a draft pick by a participating record label companies based upon their needs as well as the performance of the draft contestant. The advantage of the music industry draft process is that a group of contestants can be awarded a recording contract instead of a single individual as in other types of talent contests. Additionally, the contract is awarded based upon the needs of the record label company and not only upon the judging process in the final round.

To determine which of the participating record labels are eligible to select/draft contestants at the end of each competition and the order in which such selections take place; a number of the record labels will be randomly selected. The first record label to be randomly selected will have the right to pick first, etc. No record label will have the right to pick first in two consecutive competitions. Record labels are entitled to trade their right to pick and any picked contestants among themselves.

While certain embodiments of the present invention have been shown and described, it is to be understood that the present invention is subject to many modifications and changes without departing from the spirit and scope of the claims presented herein.

1. A method for providing a plurality of contestants each an opportunity to obtain a recording contract with a participating record label company by participating in an industry draft, the method comprising:
registering each participating record label company with a facilitating manager;
for each registered record company, issuing a predetermined number of contestant entry reward coupons, each coupon being associated with a recorded music media distributed for sale wherein a consumer obtains the reward coupons upon the purchase of the associated the recorded music media;
for a predetermined period of time repetitively, redeeming from a consumer an issued reward coupon wherein the consumer is registered into the facilitating manager for the industry draft;
selecting a set of contestants from the registered consumers, the set of contestants to compete in an auditioning process for the industry draft;
monitoring the performance of each selected contestant during the auditioning process;
selecting a final group of draft contestants based upon their performance during the auditioning process;
ranking the final group of draft contestants based upon their performance; and
drafting by the registered record companies a member from the group of ranked draft contestants for a recording contract based upon their business needs, whereby each member of the ranked group has the potential of obtaining a recording contract.

2. The method of claim 1 further comprises segmenting the auditioning process into at least two rounds.

3. The method of claim 2 wherein the monitoring step further comprises selecting a predetermined number of judges for each round of the auditioning process.

4. The method of claim 2 further comprises segmenting each round into at least one stage.

5. The method of claim 3 wherein the monitoring step further comprises selecting at least one host for each round of the auditioning process.

6. The method of claim 3 wherein the monitoring step further comprises for each round in the auditioning process:
accepting each judge vote for each performing contestant;
based upon the majority decision of the judges determining which performing contestant will advance to the next round of auditions;
accepting viewers vote for each performing contestant;
based upon the popular viewers vote determining which performing contestants will advance to the next round; and
comparing the majority decision of the judges with the popular vote of the viewers; and
based upon the comparison, determining a final decision for which performing contestants will advance to the next round of auditions.

7. The method of claim 2 wherein the segmenting step further comprises monitoring the first round of auditions to select a predetermined number of contestants from each participating state to compete in the auditioning process for the industry draft.

8. The method of claim 6 wherein the monitoring step further comprises selecting a predetermined number of draft picks to participate in the final round of auditions.

9. The method of claim 8 wherein the segmenting step further comprises creating a prioritized list of the draft picks based upon their performance during their final round of auditions.

10. The method of claim 5 further comprising the step of selecting a host for each round in the auditioning process.

11. The method of claim 2 further comprising a means for broadcasting on television at least one round of the auditioning process.

12. The method of claim 1 wherein the selecting step further comprises notifying each selected contestant the time and place for each round of auditions.

13. The method of claim 6 wherein the step of determining the final decision further comprises selecting a second panel of judges to provide a final decision when the popular vote differs from the majority decision of the judges.

14. The method of claim 1 wherein the selecting contestants step further comprises selecting by the facility manager for the inclusion in the auditioning process, any finalist from a specified non-associated talent competition.

15. A system for providing a contestant an opportunity for a recording contract with participating record labels, the system comprising:
at least one database;
a company registration component operative to register participating record label companies into the at least one database;
a consumer registration component operative to register consumers into the at least one database;
a selection process component operative to select a predetermined number of contestants from the registered consumers to compete in the industry draft;
an auditioning component operative to track and to monitor the performance of each contestant selected to compete in the industry draft; and
an industry draft selection component operative to track and to monitor the performance of each selected industry draft to participate in the final round of auditions for an recording contract from a participating recording company.

16. The system of claim 15 further comprising a database management component operative to control and to manage access to the database.

17. The system of claim 15 further comprises segmenting component operative to separate the auditioning process into at least two rounds.

18. The system of claim 17 wherein the auditioning component is further operative to select a predetermined number of judges for the auditioning process.

19. The system of claim 18 wherein the predetermined number of judges can vary during each round of the auditioning process.

20. The system of claim 17 wherein the selection component further operative to create a selection advantage for a select group of contestants for their next round of auditions based upon their performance during a previous round of auditions.

21. The system of claim 17 wherein the auditioning component is further operative to:
accept each judge vote for each performing contestant;
based upon the majority decision of the judges determine which performing contestant will advance to the next round of auditions;
accept viewers vote for each performing contestant;
based upon the popular viewers vote determine which performing contestants will advance to the next round; and
compare the majority decision of the judges with the popular vote of the viewers; and
based upon the comparison, determine a final decision for which performing contestants will advance to the next round of auditions

22. The system of claim 15 wherein the auditioning component is further operative to monitor the first round of auditions to select a predetermined number of contestants from each participating state to compete in the industry draft.

23. The system of claim 15 wherein the draft selection component is further operative to create a prioritized list of draft contestants based upon their performance during the final round of auditions.

24. The system of claim 15 wherein the auditioning component is further operative to segment each round into at least one stage.

25. The system of claim 15 wherein the auditioning component is further operative select at least one host for each round of the auditioning process.

26. A system for providing a plurality of contestants each an opportunity to obtain a recording contract with a participating record label company by participating in an industry draft, the system comprising:
a means for registering each participating record label company with a facilitating manager;
for each registered record company, a means for issuing a predetermined number of contestant entry reward coupons, each coupon being associated with a music media wherein a consumer obtains the reward coupons upon the purchase of the associated music media;
for a predetermined period of time repetitively, a means for redeeming from a consumer an issued reward coupon wherein the consumer is registered into the facilitating manager for the industry draft;
a means for selecting a set of contestants from the registered consumers, the set of contestants to compete in an auditioning process for the industry draft;
a means for monitoring the auditioning process for each selected contestant;
selecting a final group of draft contestants based upon their performance during the auditioning process;
a means for ranking the final group of draft contestants based upon their performance; and
means for drafting by the registered record companies a member from the group of ranked draft contestants for a recording contract based upon their business needs, whereby each member of the ranked group has the potential of obtaining a recording contract.

27. The system of claim 26 wherein the drafting means further comprises a means for selecting which registered record companies will participate in the draft and what order each selected registered company will participate in the draft.
